(19) United States
(12) Patent Application Publication
(10) Pub. No.: US 2019/0294323 A1
(43) Pub. Date: Sep. 26, 2019

(54) INFORMATION PROCESSING SYSTEM

(71) Applicant: FUJI XEROX CO., LTD., Tokyo (JP)

(72) Inventor: Shinobu OZEKI, Kanagawa (JP)

(73) Assignee: FUJI XEROX CO., LTD., Tokyo (JP)

(21) Appl. No.: 16/168,851

(22) Filed: Oct. 24, 2018

(30) Foreign Application Priority Data
Mar. 23, 2018 (JP) 2018-055730

(51) Int. Cl. G06F 3/0488; G06K 9/00; G06F 3/16

(52) U.S. Cl. CPC G06F 3/04883; G06F 3/16; G06K 9/00288; G06F 3/04886

(57) ABSTRACT

An information processing system includes an imaging unit that images content written by a writer on a writing surface, an information obtaining unit that obtains condition information, which is information regarding a condition under which the writer writes on the writing surface, and an information display unit that displays the condition information obtained by the information obtaining unit in an imaging area, in which the imaging unit performs imaging.

### CROSS-REFERENCE TO RELATED APPLICATIONS

This application is based on and claims priority under 35 USC 119 from Japanese Patent Application No. 2018-055730 filed Mar. 23, 2018.

### BACKGROUND

### (i) Technical Field

The present disclosure relates to an information processing system.

### (ii) Related Art

Japanese Unexamined Patent Application Publication No. 2015-161748 discloses a projection apparatus including detection means for detecting, from image data obtained by imaging means for imaging a screen, additional information added to the screen aside from visual data projected onto the screen.

Japanese Unexamined Patent Application Publication No. 2012-199678 discloses a lens control apparatus that controls a plurality of lens apparatuses provided for a stereoscopic camera that captures stereoscopic moving images.

Japanese Unexamined Patent Application Publication No. 2003-260896 discloses an electronic blackboard that reads information written on a writing surface and that stores read image data and speech sounds uttered while characters, figures, or the like corresponding to the image data were being written while associating the image data and the speech sounds with each other.

### SUMMARY

When content written on a writing surface is imaged and an imaging result is reviewed later, it is often difficult to identify information other than the written content, such as information regarding a person who has written the content. If the information other than the written content can be obtained, the written content included in the imaging result can be understood more smoothly.

Aspects of non-limiting embodiments of the present disclosure aim to make it possible to understand written content included in an imaging result more smoothly than when only an imaging result of written content on a writing surface can be reviewed later.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including an imaging unit that images content written by a writer on a writing surface, an information obtaining unit that obtains condition information, which is information regarding a condition under which the writer writes on the writing surface, and an information display unit that displays the condition information obtained by the information obtaining unit in an imaging area, in which the imaging unit performs imaging.

### BRIEF DESCRIPTION OF THE DRAWINGS

An exemplary embodiment of the present disclosure will be described in detail based on the following figures, wherein:

FIG. 1 is a diagram illustrating the overall configuration of an information processing system;

FIG. 2 is a diagram illustrating the hardware configuration of a device controller;

FIG. 3 is a diagram illustrating functional components achieved by a central processing unit (CPU) of the device controller and the like;

FIGS. 4A to 4D are diagrams illustrating an example of a process performed by the information processing system;

FIGS. 5A to 5E are diagrams illustrating an example of a process for displaying an imaging result;

FIGS. 6A to 6D are diagrams illustrating another example of the process performed by the information processing system;

FIGS. 7A to 7E are diagrams illustrating another example of the process for displaying an imaging result;

FIG. 8 is a diagram illustrating a process for registering an imaging result; and

FIG. 9 is a diagram illustrating a process for identifying a writer.

### DETAILED DESCRIPTION

An exemplary embodiment of the present disclosure will be described hereinafter with reference to the accompanying drawings.

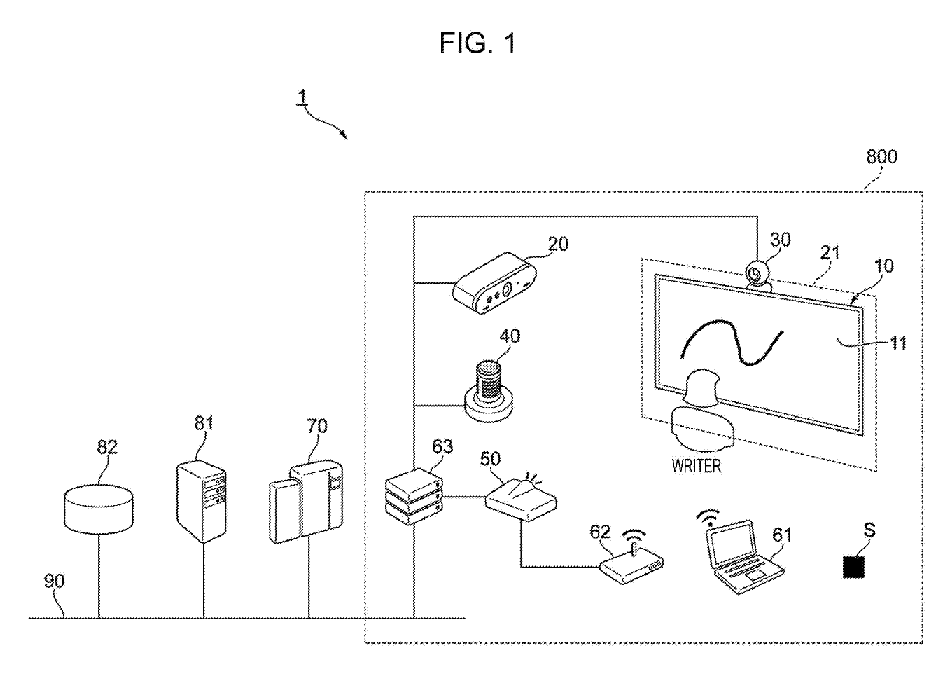

FIG. 1 is a diagram illustrating the overall configuration of an information processing system 1.

The information processing system 1 according to the present exemplary embodiment includes a whiteboard 10 on which a writer writes. The whiteboard 10 is provided in a meeting room 800.

The whiteboard 10 includes a writing surface 11 on which the writer writes. The writing surface 11 is rectangular and directed in an up-and-down direction (vertical direction). The whiteboard 10 is provided with a marker pen used for writing and an erasing member for erasing the whiteboard 10.

Although an example in which the whiteboard 10 is used will be described in the present exemplary embodiment, a blackboard may be used instead of the whiteboard 10. Alternatively, a so-called “electronic whiteboard” may be used as the whiteboard 10.

The information processing system 1 according to the present exemplary embodiment also includes a board camera 20 as an example of an imaging unit that images content written by a writer on the writing surface 11.

The board camera 20 performs imaging in a rectangular imaging area 21. In the present exemplary embodiment, the imaging area 21 in set in such a way as to include the whiteboard 10.

The information processing system 1 also includes a face detection camera 30 that is disposed above the whiteboard 10 and that detects users' faces in front of the whiteboard 10.

When users stand in front of the whiteboard 10, the face detection camera 30 detects the users and then identifies the users using a known face recognition technique.

The face detection camera 30 may be provided with a three-dimensional camera. In this case, the face detection camera 30 can detect persons' motion in more detail.

A position at which the face detection camera 30 is disposed is not limited to above the whiteboard 10. For example, the face detection camera 30 may be incorporated into a projector 50 (described later) such that the face detection camera 30 faces the whiteboard 10. Because a user's face turns to the projector 50 when he/she talks while writing on the whiteboard 10, the user's face can be detected even through the face detection camera 30 faces the whiteboard 10.

A sound input microphone 40 that obtains users' voices in front of the whiteboard 10 is also provided in the meeting room 800. The sound input microphone 40 obtains information regarding utterances made by users (speakers) around the whiteboard 10.

Sensors S such as a temperature sensor, a humidity sensor, and a brightness sensor are provided in the meeting room 800 around the whiteboard 10.

In the present exemplary embodiment, the face detection camera 30, the sound input microphone 40, the sensors S, and the like function as a part of an information obtaining unit. The face detection camera 30, the sound input microphone 40, the sensor S, and the like obtain condition information, which is information regarding a condition under which a writer writes on the whiteboard 10.

In the present exemplary embodiment, the projector 50, which is an example of an information display unit and an imaging result display unit, is also provided.

The projector 50 displays the condition information (condition information obtained by the face detection camera 30, the sound input microphone 40, the sensors S, and the like) in the imaging area 21 (on the writing surface 11 of the whiteboard 10) in which the board camera 20 performs imaging.

The projector 50 displays (projects) an imaging result obtained by the board camera 20 in the imaging area 21 (on the writing surface 11 of the whiteboard 10).

The information processing system 1 also includes a wireless communication device 62 that receives information from a personal device 61 owned by a user through wireless communication and outputs the information to the projector 50.

In the present exemplary embodiment, a device controller 63 that controls the devices provided in the meeting room 800 is also provided.

The device controller 63 obtains condition information, which is information regarding a condition around the whiteboard 10 under which a writer writes on the whiteboard 10.

More specifically, the device controller 63 obtains information (condition information) from the devices provided around the whiteboard 10 (hereinafter referred to as “peripheral devices”) such as the face detection camera 30, the sound input microphone 40, and the sensors S. More specifically, the device controller 63 obtains condition information regarding the meeting room 800 under which a writer writes on the whiteboard 10.

The device controller 63 controls the devices provided in the meeting room 800.

More specifically, for example, the device controller 63 controls the projector 50. More specifically, the device controller 63 transmits a control signal and condition information obtained from the peripheral devices to the projector 50. As a result, the whiteboard 10 displays the condition information in the present exemplary embodiment (details will be described later).

The device controller 63 also transmits a control signal and an imaging result obtained by the board camera 20 to the projector 50.

As a result, the imaging result obtained by the board camera 20 is displayed on the whiteboard 10 in the present exemplary embodiment (details will be described later).

In the present exemplary embodiment, information such as a meeting schedule in the meeting room 800 is obtained from a meeting room reservation system and stored in a management server 70.

The device controller 63 obtains information (condition information) from the peripheral devices such as the sensors S connected by wire or wirelessly and transmits the obtained information to the management server 70.

The management server 70 stores the information transmitted from the device controller 63. The management server 70 transmits information in response to a request from the device controller 63. For example, the management server 70 transmits information held thereby, such as condition information, to the device controller 63.

The information processing system 1 according to the present exemplary embodiment also includes an image database 82 storing imaging results obtained by the board camera 20 and a content server 81 that manages the imaging results registered (stored) in the image database 82.

The information processing system 1 also includes a communication channel 90 that is a local area network (LAN) or the Internet and that connects the components of the information processing system 1 to one another.

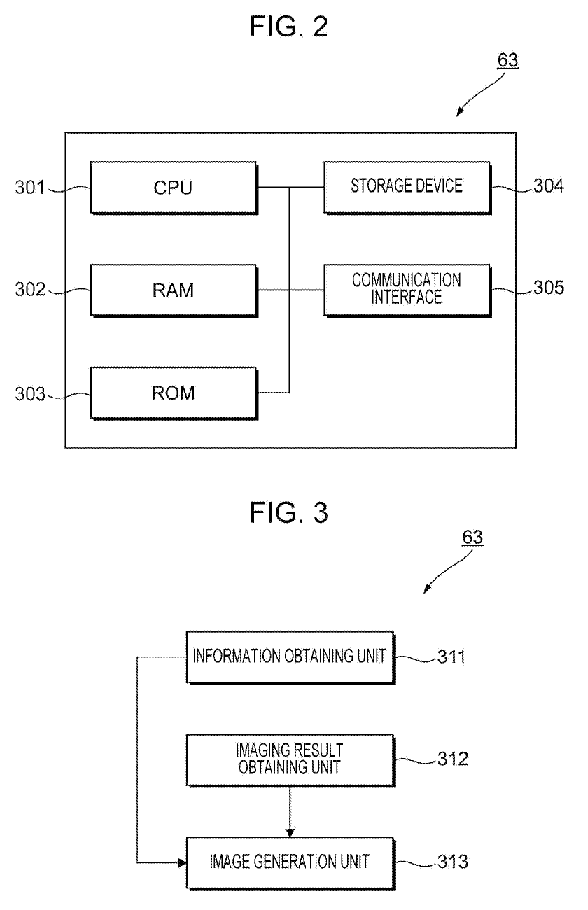

FIG. 2 is a diagram illustrating the hardware configuration of the device controller 63.

The device controller 63 is a computer and includes a CPU 301, a random-access memory (RAM) 302, and a read-only memory (ROM) 303. The device controller 63 also includes a storage device 304 such as a hard disk drive. The device controller 63 also includes a communication interface 305 for communicating with the outside.

Programs to be executed by the CPU 301 may be stored in a computer readable recording medium such as a magnetic recording medium (a magnetic tape, a magnetic disk, etc.), an optical recording medium (an optical disc, etc.), a magneto-optical recording medium, or a semiconductor memory and provided for the device controller 63. Alternatively, the programs to be executed by the CPU 301 may be downloaded to the device controller 63 through communication means such as the Internet.

FIG. 3 is a diagram illustrating functional components achieved by the CPU 301 of the device controller 63 and the like. FIG. 3 illustrates only functional components relating to a process for displaying information, which will be described later.

As illustrated in FIG. 3, the device controller 63 includes an information obtaining unit 311, an imaging result obtaining unit 312, and an image generation unit 313.

The information obtaining unit 311 that functions as another part of the information obtaining unit obtains condition information, which is information regarding a condition around the whiteboard 10 under which a writer writes on the whiteboard 10 (information regarding a condition in the meeting room 800).

More specifically, the information obtaining unit 311 obtains condition information by obtaining information from the peripheral devices provided in the meeting room 800.

The imaging result obtaining unit 312, which is an example of an imaging result obtaining unit, obtains an imaging result obtained by the board camera 20 from the board camera 20.

The imaging result obtained by the imaging result obtaining unit 312 is output to the content server 81 and stored in the image database 82.

The image generation unit 313, which is an example of a generation unit, generates image data used for an image to be displayed in the imaging area 21 of the board camera 20 from condition information obtained by the information obtaining unit 311.

The generated image data is output to the projector 50, and an image corresponding to the image data is displayed on the whiteboard 10. As a result, condition information, which is information regarding a condition around the whiteboard 10, is displayed on the whiteboard 10 in the present exemplary embodiment (details will be described later).

The image generation unit 313 also obtains, from the image database 82 (content server 81), image data (a past imaging result obtained by imaging the whiteboard 10) used for an image to be displayed in the imaging area 21 of the board camera 20.

The obtained image data is output to the projector 50, and an image corresponding to the image data is displayed on the whiteboard 10.

As a result, an imaging result obtained by the board camera 20 (a past imaging result obtained by the board camera 20 and stored in the image database 82) is displayed on the whiteboard 10 in the present exemplary embodiment (details will be described later).

Although an example in which the image database 82 and the content server 81 are separately provided has been described in the present exemplary embodiment, a single image database obtained by combining the image database 82 and the content server 81 together may be used, instead.

Alternatively, the image database 82, the content server 81, and the management server 70 storing condition information and the like may be integrated together as a single server.

In the present exemplary embodiment, during recording (registration of an imaging result), data (condition information) obtained by the information obtaining unit 311 is transmitted to the management server 70, and an imaging result obtained by the imaging result obtaining unit 312 is transmitted to the content server 81 (stored in the image database 82).

During display (display of an imaging result), on the other hand, the image generation unit 313 obtains an imaging result from the content server 81 and condition information from the management server 70, for example, on the basis of a keyword obtained from the user. The image generation unit 313 then generates a composite image by combining the imaging result and the condition information together (details will be described later).

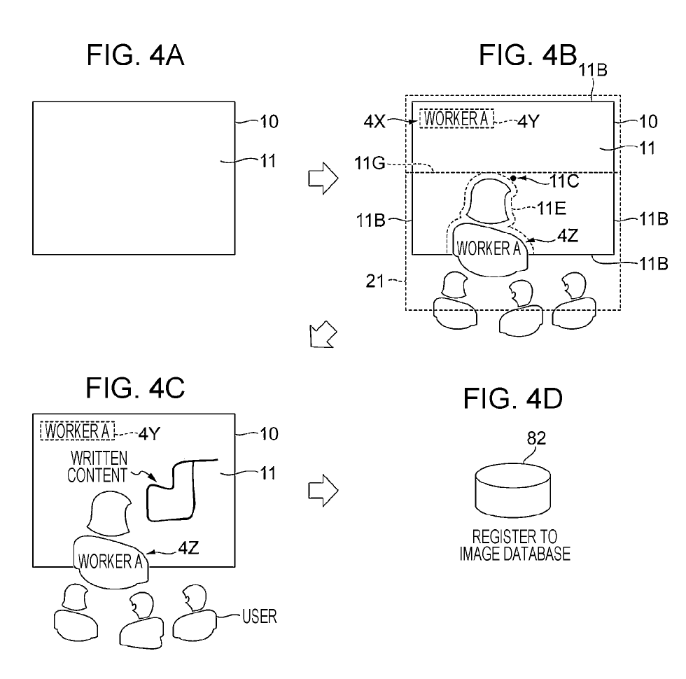

FIGS. 4A to 4D are diagrams illustrating an example of a process performed by the information processing system 1.

FIG. 4A illustrates an initial state of the whiteboard 10. In FIG. 4A, a writer has not written anything on the writing surface 11.

FIG. 4B illustrates a state in which a meeting has started and a plurality of users (persons) stand in front of the whiteboard 10.

In the present exemplary embodiment, when users stand in front of the whiteboard 10, the face detection camera 30 (refer to FIG. 1) detects the users, and the board camera 20 starts imaging.

In addition, in the present exemplary embodiment, the face detection camera 30 identifies the users in front of the whiteboard 10. More specifically, the face detection camera 30 recognizes the users' faces and identifies person identifiers (IDs) of the users in front of the whiteboard 10. The face recognition is performed using a known technique.

In addition, in the present exemplary embodiment, the face detection camera 30 identifies a person ID of a writer who is writing on the whiteboard 10.

More specifically, the face detection camera 30 determines a person who is facing the whiteboard 10 (a person who is confronting the whiteboard 10) as a writer and identifies a person ID of the writer. If there are a plurality of persons who are confronting the whiteboard 10, the face detection camera 30 determines a person whose face is the largest (a person who is closest to the whiteboard 10) as a writer and identifies a person ID of the writer.

If there are a plurality of persons whose faces are the largest (if there are a plurality of persons whose faces are the same in size), the face detection camera 30 determines the persons as writers and identifies person IDs of the persons.

In this example, a worker A illustrated in FIG. 4B is determined as a writer (a person ID of the worker A illustrated in FIG. 4B is identified).

Although the face detection camera 30 identifies person IDs of users in front of the whiteboard 10 and a person ID of a writer in the present exemplary embodiment, the device controller 63 may perform the identification, instead.

After the person ID is identified, detail information regarding the writer is output to the projector 50 through the device controller 63 that has issued a request to the management server 70 in the present exemplary embodiment. The detail information regarding the writer is then displayed on the writing surface 11 as indicated by a reference numeral 4X in FIG. 4B.

More specifically, the management server 70 issues a request to a person information system on the basis of a person ID identified by the face detection camera 30 or the device controller 63 and obtains detail information such as a name. In the present exemplary embodiment, the detail information is then output to the projector 50 through the device controller 63 and displayed on the writing surface 11.

More specifically, in the present exemplary embodiment, the information obtaining unit 311 of the device controller 63 obtains the detail information obtained by the management server 70, and the image generation unit 313 generates, on the basis of the detail information, image data used for an image to be displayed on the writing surface 11. The image data is output to the projector 50. As a result, the information regarding the writer identified by the face detection camera 30 or the like is displayed on the writing surface 11.

In the present exemplary embodiment, the detail information regarding the writer is displayed in the imaging area 21 of the board camera 20. In other words, in the present exemplary embodiment, condition information regarding a condition around the writing surface 11 under which the writer writes on the writing surface 11 is displayed on the writing surface 11 of the whiteboard 10.

More specifically, in the present exemplary embodiment, the projector 50, which is an example of the information display unit, displays condition information obtained by the information obtaining unit 311 on the writing surface 11 in a predetermined display part 4Y (refer to FIG. 4B).

More specifically, in the present exemplary embodiment, a text image “Worker A” is projected in an upper-left part of the writing surface 11.

In the present exemplary embodiment, the information obtaining unit 311 obtains information (condition information) from the peripheral devices provided in the information obtaining unit 311.

In the present exemplary embodiment, the obtained condition information is then output to the projector 50, which in turn displays the condition information on the whiteboard 10.

In the present exemplary embodiment, obtained condition information is not only displayed on the writing surface 11 but also registered to the management server 70 while being associated with imaging results obtained by the board camera 20 (imaging results stored in the image database 82).

More specifically, in the present exemplary embodiment, writer information, information regarding users other than a writer, environment information such as temperature inside the meeting room 800, utterance information, and the like are obtained as condition information. These pieces of information are registered to the management server 70 while being associated with imaging results.

In the present exemplary embodiment, when condition information is displayed on the writing surface 11 of the whiteboard 10, the condition information is displayed in a part that is not hidden by a writer.

More specifically, in the present exemplary embodiment, information regarding a writer (writer information) is displayed on the writing surface 11 as condition information as indicated by the reference numeral 4X in FIG. 4B. At this time, the condition information is displayed in a part that is not hidden by a writer 4Z.

More specifically, the condition information is displayed in an upper part of the writing surface 11. More specifically, in the present exemplary embodiment, the condition information is displayed in an upper-left part of the writing surface 11 (at an upper-left corner of the writing surface 11).

In the present exemplary embodiment, the condition information is displayed on the writing surface 11 at a position closer to an edge 11B of the writing surface 11 than to a center 11C of the writing surface 11.

In the present exemplary embodiment, the condition information is displayed on the writing surface 11 in a part higher than a part 11E facing the writer 4Z. More specifically, the condition information is displayed in a part higher than a broken line 11G.

By displaying the condition information in the above-described manner, the condition information is not hidden behind the writer 4Z and can be seen by the other users.

Although an example in which writer information is displayed as condition information has been described in the present exemplary embodiment, another type of information may be displayed, instead.

For example, information regarding users around the writing surface 11, for example, may be displayed as condition information. That is, information regarding the users other than the writer 4Z may be displayed.

Alternatively, information (utterance information) regarding utterances made by a writer and users (utterers) around the writing surface 11 may be displayed as condition information.

When utterance information is to be displayed, the sound input microphone 40 obtains the utterance information. The information obtaining unit 311 of the device controller 63 then obtains the utterance information from the sound input microphone 40.

The image generation unit 313 analyzes the utterance information from the sound input microphone 40 to convert the utterance information into text information. The image generation unit 313 then outputs the text information to the projector 50. The utterance information is thus displayed on the writing surface 11.

Alternatively, environment information (information regarding an environment in the meeting room 800), which is information regarding an environment around the writing surface 11, may be displayed as condition information.

More specifically, information regarding temperature, humidity, illuminance, and the like obtained by the sensors S may be displayed.

Alternatively, time information and location information indicating an installation location of the writing surface 11 or the like may be displayed as condition information.

After the condition information is displayed, the displayed condition information may be sequentially switched to display various types of condition information.

Alternatively, a plurality of pieces of condition information may be displayed on the writing surface 11.

When a plurality of pieces of condition information are displayed, it is desirable to predetermine priority levels of the plurality of pieces of condition information.

The size of the writing surface 11 varies. When the writing surface 11 is small, it might be difficult to display all types of condition information, and it might be necessary to select types of condition information to be displayed. If priority levels are predetermined in this case as described above, types of condition information to be displayed can be smoothly selected.

In the present exemplary embodiment, if the writer 4Z changes to a new writer, writer information regarding the new writer is displayed.

In the present exemplary embodiment, the writer 4Z is identified and information regarding the writer 4Z is displayed in real-time (at predetermined time intervals). If the writer 4Z changes to a new writer, writer information corresponding to the new writer is displayed.

FIG. 4C is a diagram illustrating a state after the writer writes on the writing surface 11.

In the present exemplary embodiment, the board camera 20 (refer to FIG. 1) images the writer 4Z, the users other than the writer 4Z, and the writing surface 11 of the whiteboard 10 illustrated in FIG. 4C.

The writer 4Z has written on the writing surface 11 of the whiteboard 10, and the condition information has been displayed on the writing surface 11 of the whiteboard 10. In the present exemplary embodiment, written content and the condition information on the writing surface 11 are imaged by imaging the writing surface 11.

An imaging result obtained by the board camera 20 is registered to the image database 82.

More specifically, the imaging result obtained by the board camera 20 is output to the content server 81, and the content server 81 registers the imaging result to the image database 82.

Here, the content server 81 registers the imaging result to the image database 82 as a still image, not as a moving image.

In the present exemplary embodiment, the content server 81 and the image database 82 function as a storage unit storing imaging results obtained by the board camera 20. The content server 81 and the image database 82 store imaging results from the board camera 20 as still images.

In the present exemplary embodiment, if a imaging result obtained by the board camera 20 changes, the imaging result is registered to the image database 82.

More specifically, in the present exemplary embodiment, the content server 81 determines whether an imaging result from the board camera 20 has changed. If so, the imaging result is registered to the image database 82 as illustrated in FIG. 4D.

An imaging result may be uniformly registered to the image database 82 each time the imaging result has changed. Alternatively, if an imaging result changes in a predetermined part, the imaging result need not be registered.

More specifically, for example, if an imaging result changes in the display part 4Y (refer to FIG. 4C) of the condition information, the imaging result need not be registered.

In other words, even if an imaging result changes in the display part 4Y, the imaging result need not be registered insofar as the imaging result has not changed in other parts.

More specifically, in the present exemplary embodiment, the content server 81 analyzes an imaging result. If the imaging result changes, the imaging result is registered. If the imaging result changes in the display part 4Y, however, the registration of the imaging result may be omitted.

In the present exemplary embodiment, content displayed in the display part 4Y might be switched. If an imaging result is uniformly registered in this case, the imaging result is undesirably registered even though written content has not been changed.

If an imaging result changes only in the display part 4Y and is not registered as in the present exemplary embodiment, on the other hand, the number of imaging results registered is reduced, thereby reducing the amount of memory used in a storage device for storing imaging results.

Alternatively, an imaging result may be registered to the image database 82 if the imaging result changes and writing performed by a writer on the writing surface 11 is detected.

In this case, imaging results are not registered when a writer has not written on the writing surface 11.

There is a case, for example, where the projector 50 displays a material on the writing surface 11 and pages of the material are turned. In this case, if an imaging result is registered only after writing performed by a writer is detected as described above, imaging results are not registered when the pages are turned. In other words, when a writer has not written anything, an imaging result is not registered.

Writing performed by a writer on the writing surface 11 can be detected, for example, by providing a vibration sensor that detects vibration of the writing surface 11.

If an imaging result is registered to the image database 82 and condition information included in the imaging result is the same as condition information included in a previous imaging result, the condition information displayed on the writing surface 11 may be changed, and an imaging result after the condition information is changed may be registered.

If the same writer consecutively writes, for example, the same writer information is consecutively displayed as condition information in the present exemplary embodiment. In this case, when imaging results are reviewed later, only the writer information is obtained as the condition information.

If displayed information is changed as described above, on the other hand, different pieces of condition information can be obtained when imaging results are reviewed later.

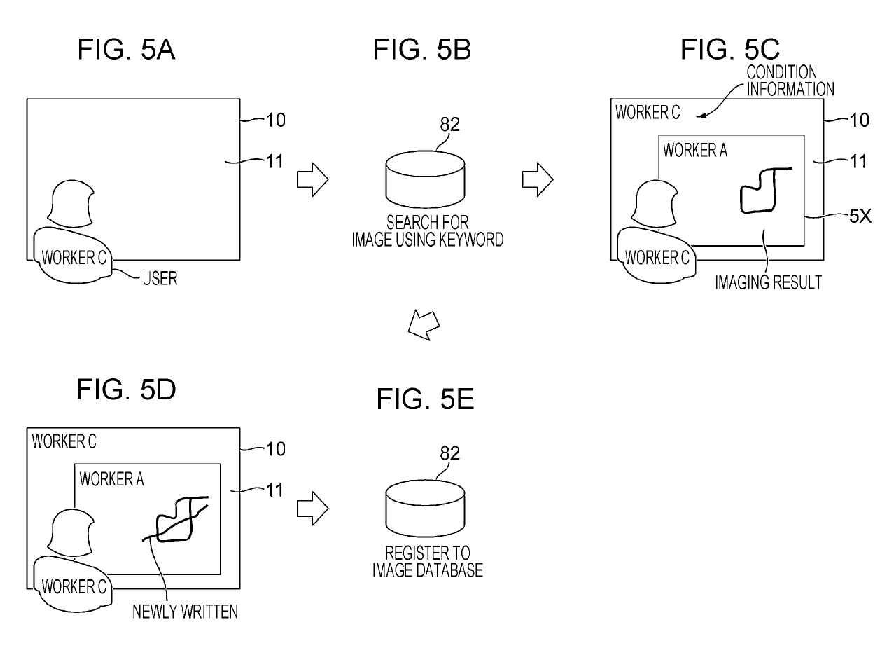

FIGS. 5A to 5E are diagrams illustrating an example of a process for displaying an imaging result.

In the present exemplary embodiment, an imaging result registered in the image database 82 is displayed on the writing surface 11 in accordance with an instruction from a user.

When an imaging result is displayed in the present exemplary embodiment, a user (a worker C in this example) inputs a keyword for identifying the imaging result using the sound input microphone 40 (refer to FIG. 1) as illustrated in FIG. 5A.

The content server 81 then searches imaging results stored in the image database 82 for an imaging result corresponding to the keyword as illustrated in FIG. 5B.

Next, as illustrated in FIG. 5C, the projector 50 (refer to FIG. 1), which is an example of the imaging result display unit, displays the imaging result on the writing surface 11 of the whiteboard 10. More specifically, in the present exemplary embodiment, the imaging result identified by the content server 81 is output to the projector 50 through the device controller 63 and displayed on the writing surface 11 of the whiteboard 10.

In the present exemplary embodiment, when the imaging result is displayed on the writing surface 11, at least an imaging part of the imaging result, the imaging part being obtained by imaging the writing surface 11, is displayed on the writing surface 11.

More specifically, a rectangular area 5X illustrated in FIG. 5C corresponds to an imaging part obtained by imaging the writing surface 11 (hereinafter referred to as a “writing surface imaging part”). At least the writing surface imaging part is displayed on the writing surface 11.

In the present exemplary embodiment, the writing surface imaging part is displayed while changing the size of the writing surface imaging part.

More specifically, in the present exemplary embodiment, the size of the writing surface imaging part is reduced, and the writing surface imaging part smaller than the writing surface 11 is displayed.

In addition, in the present exemplary embodiment, condition information obtained by the information obtaining unit 311 is displayed on the writing surface 11 in a blank space around a display part in which the writing surface imaging part is displayed (a blank space outside the rectangular area 5X).

If a writing surface imaging part smaller than the writing surface 11 is displayed as in the present exemplary embodiment, a blank space is caused around the writing surface imaging part. In the present exemplary embodiment, condition information at the time is displayed in the blank space. More specifically, in this example, information (writer information) indicating that the writer is the worker C is displayed as condition information.

Although a blank space is caused by reducing the writing surface imaging part in size in the present exemplary embodiment, a blank space may be caused by displaying a portion of the writing surface imaging part, instead. In other words, a blank space may be caused by omitting a portion of the writing surface imaging part.

When a writing surface imaging part is displayed, the size of the writing surface imaging part may be increased, instead. More specifically, for example, a portion of the writing surface imaging part may be omitted, and the rest of the writing surface imaging part may be enlarged. In this case, the writing surface imaging part is expanded, and details can be easily checked.

When a writing surface imaging part is displayed (played back), the writing surface imaging part may be automatically or manually played back. The writing surface imaging part may also be rewound.

Although an example in which a writing surface imaging part is displayed in accordance with an instruction issued by a user using the sound input microphone 40 has been described in the present exemplary embodiment, a writing surface imaging part may be displayed by receiving an instruction from a user through a mobile terminal such as a tablet.

When a writing surface imaging part is displayed (written content is displayed), a plurality of drawn lines (strokes) consisting the written content may be displayed one by one in chronological order.

If a plurality of drawn lines consisting written content include drawn lines written by different writers, a writing surface imaging part (written content) may be displayed such that a writer of each drawn line can be identified. More specifically, for example, different colors of drawn lines may be used for different writers, or different backgrounds of drawn lines may be used for different writers.

Thereafter, in this example, the writer (worker C) newly writes on the writing surface 11 as illustrated in FIG. 5D.

In this example, the board camera 20 then images new written content, an imaging result (writing surface imaging part) displayed by the projector 50 on the writing surface 11, and the condition information displayed by the projector 50 on the writing surface 11.

An imaging result obtained by the board camera 20 is then registered to the image database 82 as illustrated in FIG. 5E. The condition information is registered to the management server 70 while being associated with the imaging result registered to the image database 82.

Although an example in which a past imaging result is displayed on the whiteboard 10 and a user checks the past imaging result by looking at the whiteboard 10 has been described in the present exemplary embodiment, the method for checking an imaging result is not limited to this.

For example, an imaging result may be transmitted to a terminal apparatus (not illustrated) such as a personal computer (PC) or a tablet terminal, and a user may check the imaging result on the terminal apparatus, instead.

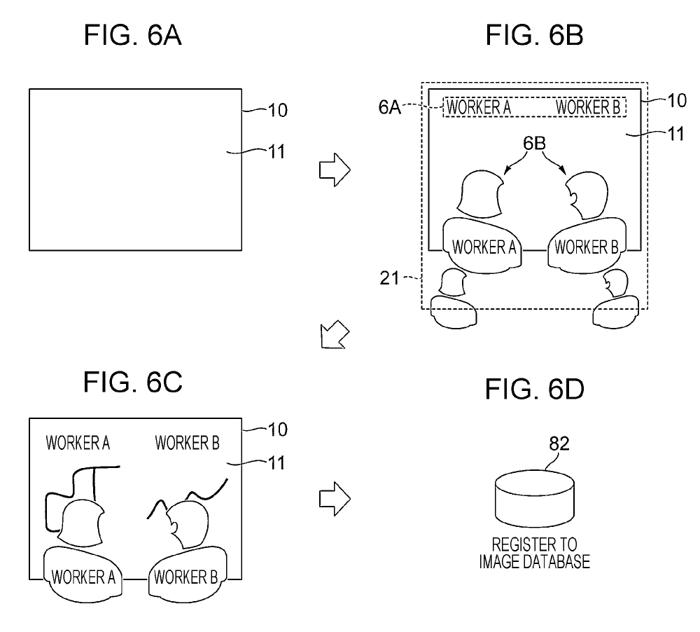

FIGS. 6A to 6D are diagrams illustrating another example of the process performed by the information processing system 1. More specifically, FIGS. 6A to 6D are diagrams illustrating an example of a process at a time when a writer writes on the whiteboard 10.

In this example, too, the writer is identified, and information regarding the identified writer is displayed on the writing surface 11 in a display part 6A illustrated in FIG. 6B. In other words, in this case, too, the information regarding the identified writer is displayed in the imaging area 21 of the board camera 20.

More specifically, in this example, there are a plurality of writers. In this case, a plurality of pieces of writer information are displayed for the writers.

More specifically, in this example, the worker A and a worker B stand in front of the whiteboard 10 as writers. Pieces of writer information “Worker A” and “Worker B” are displayed on the whiteboard 10 for the workers A and B.

If it is determined that there are a plurality of writers in the present exemplary embodiment, correspondences between the writers and written content are identified from positions of faces of the detected writers and positions of the written content on the whiteboard 10. The written content (drawn lines) and the writers are then registered to the image database 82 while being associated with each other.

In the present exemplary embodiment, the plurality of pieces of writer information are displayed such that positions of writers and positions of the plurality of pieces of writer information match.

More specifically, in the present exemplary embodiment, the workers A and B (writers 6B illustrated in FIG. 6B), who are a plurality of writers, stand in this order from left to right in FIG. 6B.

In addition, in the present exemplary embodiment, the pieces of writer information (writer information displayed in the display part 6A), namely “Worker A” and “Worker B”, are displayed on the writing surface 11 in this order from left to right in FIG. 6B.

As a result, in the present exemplary embodiment, information regarding writers can be understood more accurately than when positions of writers and positions of a plurality of pieces of writer information do not match.

In the present exemplary embodiment, the pieces of writer information are displayed in a part higher than a part facing the writers.

In this example, the writers A and B then write on the writing surface 11 as illustrated in FIG. 6C. An imaging result on the writing surface 11 obtained by the board camera 20 is then registered to the image database 82 as illustrated in FIG. 6D.

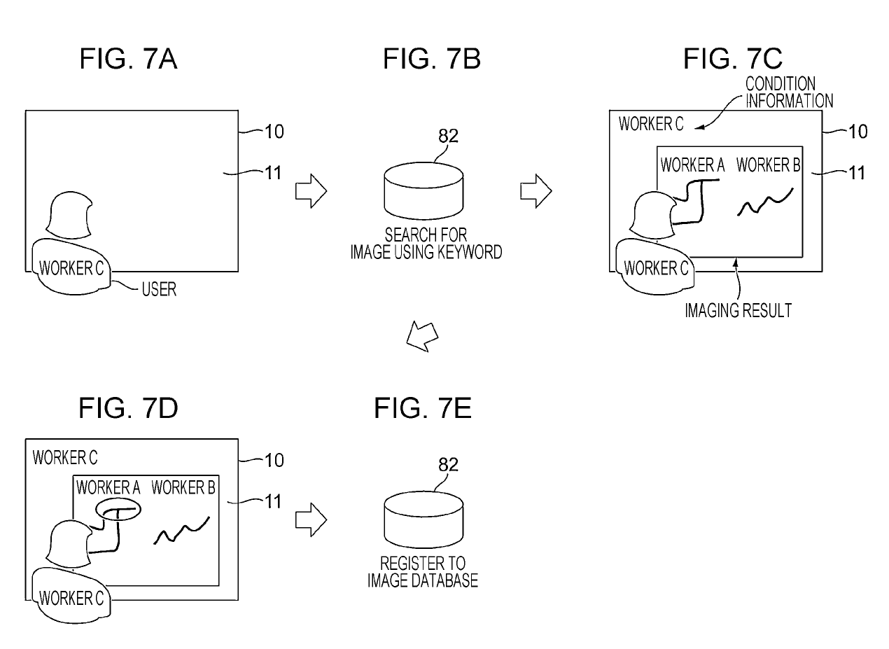

FIGS. 7A to 7E are diagrams illustrating another example of the process for displaying an imaging result.

In the process for displaying an imaging result, too, a user (the worker C in this example) speaks to the sound input microphone 40 (refer to FIG. 1) as illustrated in FIG. 7A.

As in the above example, imaging results stored in the image database 82 are then searched as illustrated in FIG. 7B.

If an imaging result is identified, the identified imaging result is displayed on the writing surface 11 as illustrated in FIG. 7C. At this time, as in the above example, the imaging result is reduced in size and displayed on the writing surface 11. Condition information is displayed in a blank space caused as a result of the reduction in size.

As in the above example, if the worker C newly writes on the writing surface 11, a new imaging result (a new imaging result obtained by the board camera 20) obtained by imaging new written content, the imaging result (the projected past imaging result), and the condition information is registered to the image database 82 as illustrated in FIGS. 7D and 7E.

In the information processing system 1 according to the present exemplary embodiment, an imaging result of written content is saved, and details of a meeting can be identified by reviewing the written content later.

In this case, in the present exemplary embodiment, not only an imaging result of written content but also condition information such as writer information can be referred to. In this case, the written content can be checked while taking into consideration the condition information, and the written content can be understood more smoothly. That is, in the present exemplary embodiment, a background condition when a writer has written can be identified, and past written content can be understood more smoothly.

The process according to the present exemplary embodiment may be employed for teleconferences.

When the process is employed for teleconferences, it becomes easier to check content written at one location from another location.

More specifically, a user at the other location can understand not only content written at the one location but also background information at the one location. At the other location, therefore, a user can check the content written at the one location more easily.

Although an example in which a writer directly writes on the writing surface 11 has been described above, a writer need not directly writes on the writing surface 11. A writer may attach, to the writing surface 11, a recording medium, such as a label, on which the writer has written.

In this case, too, content written on the recording medium can be understood more smoothly by displaying condition information.

Although an example in which condition information is projected onto the writing surface 11 and image data regarding an image including both written content and the condition information is generated by imaging the writing surface 11 has been described above (although a case an imaging result including both written content and condition information is obtained has been described above), the image data including both the written content and the condition information may be generated using another method, instead.

More specifically, for example, an image indicating condition information may be combined with an imaging result of the writing surface 11, and image data regarding an image including both written content and the condition information may be generated.

More specifically, in this case, for example, the image generation unit 313, which functions as the generation unit, generates image data used for an image to be combined with an imaging result of the writing surface 11 (an imaging result stored in the image database 82) using condition information stored in the management server 70.

The image generation unit 313 then combines the generated image data with the imaging result of the writing surface 11 to generate image data regarding an image including both written content and the condition information.

In other words, in this case, the image generation unit 313 generates image data regarding an image including both written content and condition information using condition information stored in the management server 70 and an imaging result associated with the condition information (an imaging result stored in the image database 82). In other words, the image generation unit 313 generates a composite image obtained by combining an imaging result and condition information together.

Although a case where condition information is displayed on the writing surface 11 has been described above, condition information may be displayed in a part other than the writing surface 11, instead. More specifically, condition information may be displayed in the imaging area 21 in a part other than the writing surface 11.

Although a single apparatus (projector 50) displays both an imaging result and condition information in the above description, an apparatus that displays an imaging result and an apparatus that displays condition information may be separately provided, instead.

Although condition information and an imaging result are displayed through projection in the above description, a display apparatus such as a display may display condition information and an imaging result, instead.

Although a case where an imaging result is saved as a still image has been described above, an imaging result may be saved as a moving image, instead. Time taken to display an imaging result, however, is shorter when a still image is used.

When an imaging result is saved as a moving image, too, it is desirable to save the imaging result if written content changes.

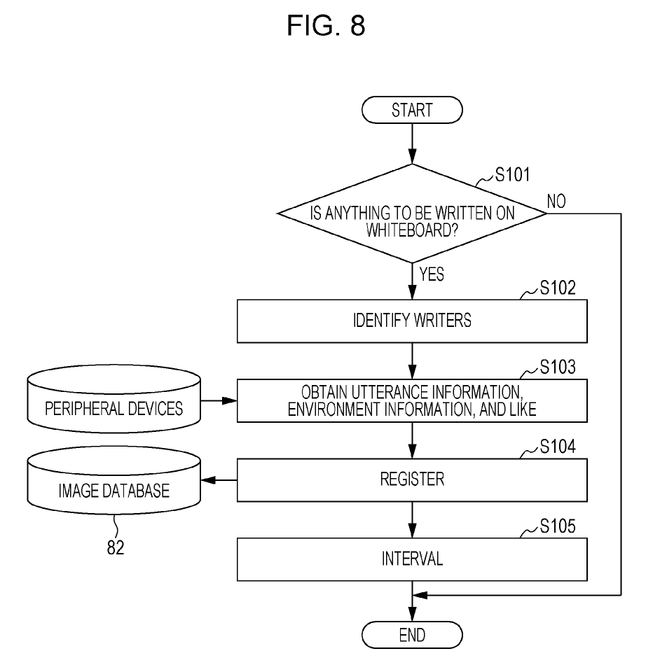

FIG. 8 is a diagram illustrating a process for registering an imaging result.

In the process according to the present exemplary embodiment, first, whether something is to be written on the whiteboard 10 is determined (step S101).

More specifically, whether there is a person that can be a writer in front of the whiteboard 10 on the basis of an output of the face detection camera 30. If so, it is determined that something is to be written on the whiteboard 10.

Next, condition information is obtained in the present exemplary embodiment.

More specifically, first, the face detection camera 30 recognizes faces to identify writers in front of the whiteboard 10 (step S102). More specifically, person IDs of the writers are identified. Detail information regarding the writers is then obtained as described above on the basis of the person IDs.

Utterance information, environment information, and the like are also obtained from the peripheral devices provided in the meeting room 800 (step S103).

In the present exemplary embodiment, if something is written on the writing surface 11, an imaging result (an imaging result obtained by the board camera 20) including written content and condition information is registered to the image database 82 (step S104). The condition information is registered to the management server 70 while being associated with the imaging result.

The process ends after a predetermined period of time elapses (step S105).

In the present exemplary embodiment, steps S101 to S103 are repeatedly performed, and if something is written on the writing surface 11, step S104 is performed to register an imaging result to the image database 82.

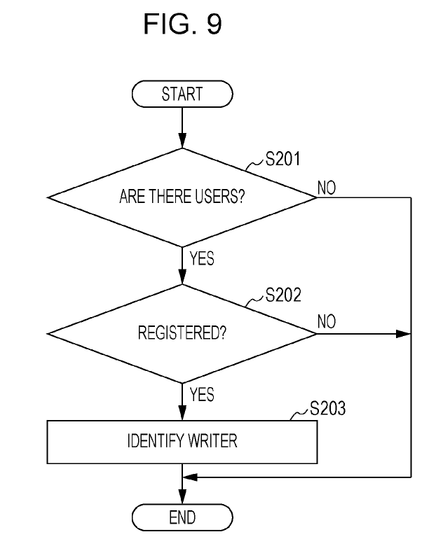

FIG. 9 is a diagram illustrating the process performed in step S102 (a process for identifying a writer).

In this process, first, the face detection camera 30 analyzes an imaging result obtained thereby to determine whether there are users in front of the whiteboard 10 (step S201).

If determining in step S201 that there are users in front of the whiteboard 10, the face detection camera 30 determines whether the users have been registered in a user information database (not illustrated) to which user information has been registered in advance (step S202).

If the users have been registered, the face detection camera 30 obtains person IDs (information for identifying the users) of the users from the user information database.

The face detection camera 30 then obtains a person ID of a person facing the whiteboard 10 (a person confronting the whiteboard 10) from the obtained person IDs and identifies a writer on the basis of the obtained person ID (obtains detail information regarding the writer) (step S203). More specifically, as described above, the management server 70 issues a request to the person information system to obtain detail information regarding the writer and identify the writer.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
an imaging unit that images content written by a writer on a writing surface;
an information obtaining unit that obtains condition information, which is information regarding a condition under which the writer writes on the writing surface; and
an information display unit that displays the condition information obtained by the information obtaining unit in an imaging area, in which the imaging unit performs imaging.

2. The information processing system according to claim 1,
wherein the information display unit displays the condition information obtained by the information obtaining unit on the writing surface.

3. The information processing system according to claim 2,
wherein the information display unit displays the condition information obtained by the information obtaining unit on the writing surface in a part that is not hidden by the writer.

4. The information processing system according to claim 3,
wherein the information display unit displays the condition information on the writing surface in a part higher than a part facing the writer.

5. The information processing system according to claim 2,
wherein the information display unit displays the condition information on the writing surface at a position closer to an edge of the writing surface than to a center of the writing surface.

6. The information processing system according to claim 2,
wherein the information display unit displays the condition information in an upper part of the writing surface.

7. The information processing system according to claim 1,
wherein the information display unit displays the condition information obtained by the information obtaining unit in a part that is not hidden by the writer.

8. The information processing system according to claim 1,
wherein the information obtaining unit obtains information regarding a user around the writing surface as the condition information, and
wherein the information display unit displays the information regarding the user around the writing surface.

9. The information processing system according to claim 1,
wherein the information obtaining unit obtains writer information, which is information regarding the writer, as the condition information, and
wherein the information display unit displays the writer information.

10. The information processing system according to claim 9,
wherein, if there are a plurality of writers, the information display unit displays a plurality of pieces of the writer information corresponding to the plurality of writers.

11. The information processing system according to

10,
wherein the information display unit displays the plurality of pieces of the writer information such that positions of the plurality of writers and positions of the plurality of pieces of the writer information match.

12. The information processing system according to claim 1,
wherein the information obtaining unit obtains information regarding an utterance made by an utterer around the writing surface as the condition information, and
wherein the information display unit displays the information regarding the utterance.

13. The information processing system according to claim 1,
wherein the information obtaining unit obtains information regarding an environment around the writing surface as the condition information, and
wherein the information display unit displays the information regarding the environment.

14. The information processing system according to claim 1, further comprising:
a storage unit that stores an imaging result obtained by the imaging unit,
wherein the storage unit stores the imaging result obtained by the imaging unit if the imaging result changes.

15. The information processing system according to claim 14,
wherein the information display unit displays the condition information obtained by the information obtaining unit in a predetermined display part, and
wherein, even when a part of the imaging result obtained by imaging the predetermined display part has changed, the storage unit does not store the imaging result if a remaining part of the imaging result does not change.

16. The information processing system according to claim 1, further comprising:
a storage unit that stores an imaging result obtained by the imaging unit,
wherein the storage unit stores the imaging result obtained by the imaging unit if the imaging result changes and writing performed by the writer on the writing surface is detected.

17. The information processing system according to claim 1, further comprising:
an imaging result display unit that displays an imaging result obtained by the imaging unit on the writing surface.

18. The information processing system according to claim 17,
wherein the imaging unit images both the imaging result displayed by the imaging result display unit on the writing surface and content written on the writing surface with the imaging result displayed.

19. The information processing system according to claim 17,
wherein the imaging result display unit displays, on the writing surface, at least an imaging part of the imaging result obtained by the imaging unit, the imaging part being obtained by imaging the writing surface, and, when displaying at least the imaging part of the imaging result, displays a portion of the imaging part or displays the imaging part while changing size of the imaging part.

20. The information processing system according to claim 19,
wherein, when displaying the imaging part while changing the size of the imaging part, the imaging result display unit displays the imaging part smaller than the writing surface.

21. The information processing system according to claim 20,
wherein the information display unit displays the condition information obtained by the information obtaining unit on the writing surface in a blank space around a part in which the imaging part is displayed.

22. An information processing system comprising:
an information obtaining unit that obtains condition information, which is information regarding a condition under which a writer writes on a writing surface; and
a generation unit that generates image data regarding an image including content written on the writing surface and the condition information obtained while the writer is writing the content.

23. An information processing system comprising:
an information obtaining unit that obtains condition information, which is information regarding a condition under which a writer writes on a writing surface;
an imaging result obtaining unit that obtains an imaging result obtained by an imaging unit that images the writing surface; and
a generation unit that generates, from the condition information obtained by the information obtaining unit, image data used for an image to be displayed in an imaging area of the imaging unit or image data used for an image to be combined with an imaging result of the writing surface.
